(19) United States
(12) Patent Application Publication
(10) Pub. No.: US 2024/0253540 A1
(43) Pub. Date: Aug. 1, 2024

(54) SEAT IMPULSE DEVICE FOR THE REDUCTION OF SPINAL TENSION LOADS RESULTING FROM A FREE FLAIL EVENT

(71) Applicant: B/E Aerospace, Inc., Winston-Salem, NC (US)

(72) Inventor: Mark B. Dowty, Rural Hall, NC (US)

(21) Appl. No.: 18/602,703

(22) Filed: Mar. 12, 2024

Related U.S. Application Data
(63) Continuation-in-part of application No. 17/705,614, filed on Mar. 28, 2022.

(51) Int. Cl. B60N 2/42; B60N 2/427; B60R 21/207

(52) U.S. Cl. CPC B60N 2/4221; B60N 2/4279; B60R 21/207

(57) ABSTRACT

A safety seat system and method for delivering a compression load to a passenger during a frontal deceleration event is disclosed. The system may include a seat frame, a seat back, and an impulse generator coupled to the seat back configured to provide a compression load onto a spine of a sitting passenger during a forward deceleration event. The system further includes a controller configured to receive a forward deceleration signal from the inertial sensor and activate the impulse generator based on the forward deceleration signal. The impulse generator may generate the compression load via an airbag, mechanically stored energy, a solenoid switch, or via a rotating cam assembly.

### CROSS REFERENCE TO RELATED APPLICATION

The present application claims the benefit under 35 U.S.C. § 120 of U.S. patent application Ser. No. 17/705,614, filed on Mar. 28, 2022, which is hereby incorporated by reference in its entirety.

### BACKGROUND

Seat belts are designed to prevent serious injury in vehicle accidents. However, in high-speed accidents, a sudden deceleration may cause a passenger's spine to experience high tension loads as the passenger jerks forward violently. These high-tension loads are particularly dangerous for front row passengers that do not have an aft portion of a seatback in front of them to slow down forward momentum. These “free flail” passengers could be further protected via 3-point or 5-point harness systems, passenger-containing airbags or other restraint system. However, these products are often heavy, and may require structural reinforcement to withstand load. Therefore, it is desirable to provide a system that safely protects passengers during sudden decelerations that are without the limitations of current safety devices.

### SUMMARY

A safety seat system and method for delivering a compression load to a passenger during a frontal deceleration event is disclosed in accordance with one or more illustrative embodiments of the present disclosure. In one illustrative embodiment, the system may include a seat frame, a seat back, and an impulse generator coupled to the seat back configured to provide the compression load onto a spine of a sitting passenger during a forward deceleration event. In another illustrative embodiment, the system further includes a controller configured to receive a forward deceleration signal from the inertial sensor and activate the impulse generator based on the forward deceleration signal. In another illustrative embodiment, the impulse generator may generate the compression load via an airbag, mechanically stored energy, a solenoid switch, or via a rotating cam assembly.

A method for delivering a compression load to a passenger is disclosed in accordance with one or more illustrative embodiments of the present disclosure. In one illustrative embodiment, the method may include detecting a forward deceleration event. In another illustrative embodiment, the method may include transmitting a forward deceleration event signal to a controller. In another illustrative embodiment, the method may include activating an impulse generator via the controller. In another illustrative embodiment, the method may include delivering a compression load to the passenger based on the forward deceleration event signal.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a diagram of a safety seat system 100, in accordance with one or more embodiments of the disclosure.

FIG. 1B is a block diagram illustrating the electronic componentry of the safety seat system 100, in accordance with one or more embodiments of the disclosure.

FIG. 2A are diagrams conceptually illustrating the safety seat system under normal travel conditions, in accordance with one or more embodiments of the disclosure.

FIG. 2B are diagrams conceptually illustrating the safety seat system immediately after impulse generator activation during a forward deceleration event, in accordance with one or more embodiments of the disclosure.

FIG. 3 is a diagram illustrating the safety seat system, wherein an energy source drives a load plate, in accordance with one or more embodiments of the disclosure.

FIG. 4 is a block diagram illustrating a method for delivering a compression load to a passenger, in accordance with one or more embodiments of the disclosure.

FIG. 5 is a chart illustrating lumbar tension versus time with and without an impulse, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Note that the present disclosure is, at least in part, related to U.S. patent application Ser. No. 17/705,614, filed Mar. 28, 2022, entitled SEAT PAN IMPULSE DEVICE FOR THE REDUCTION OF SPINAL TENSION LOADS RESULTING FROM A FREE FLAIL EVENT, which is hereby incorporated by reference in its entirety. It is contemplated herein, that delivering loads (i.e., impulses) that are closer to a forward/longitudinal direction (e.g., X-axis), rather than a vertical direction (e.g., Z-axis), may provide a more desirable lumber tension profile over time in the event of a free flail incident. For example, an impulse generator may be located in, but is not necessarily limited to, the seat back (e.g., behind a lower back of a passenger) and may provide for a more desirable lumbar tension profile than an impulse generator located in a seat pan. Further, it is contemplated herein, that airbag styles of impulse generators may, in some embodiments, be used to generate such a load.

A safety seat system for a vehicle that can reduce spinal loads during a free flail incident (e.g., crash) is disclosed. The safety seat system may include a seat back and impulse generator configured to deliver a compression load, or a near compression load, to the spine of a sitting passenger. For example, a load (i.e., force, impulse and the like) may be applied to a lower back area and/or gluteus muscle area of a passenger to reduce the maximum/peak lumbar tension experienced during a free flail incident. The compression load reduces spinal tension loads that occurs during a sudden deceleration of a vehicle. By countering the spinal tension loads, injury to the spine, pelvis, and other aspects of the passenger are reduced.

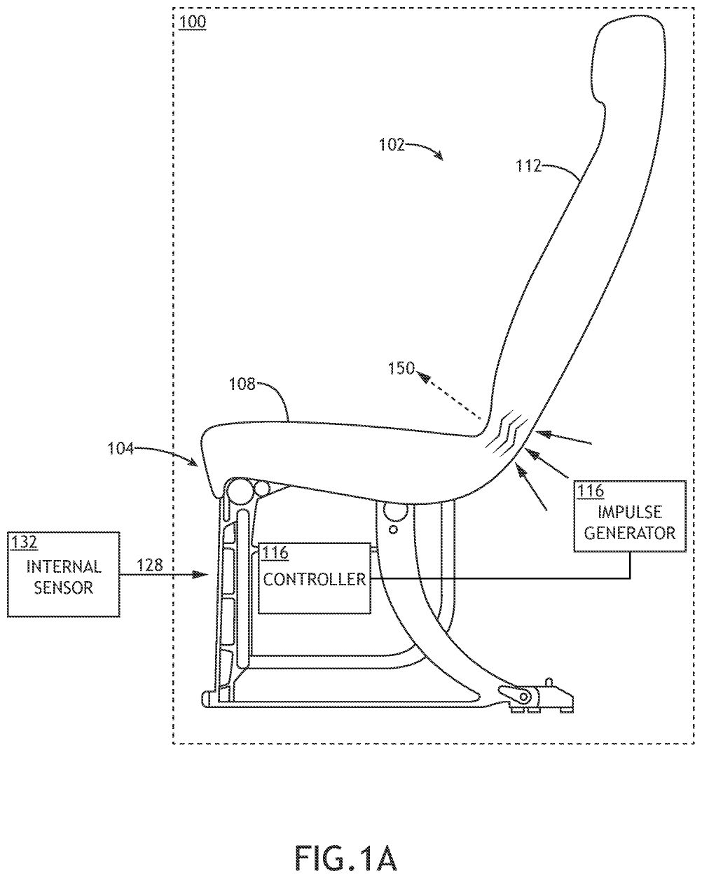

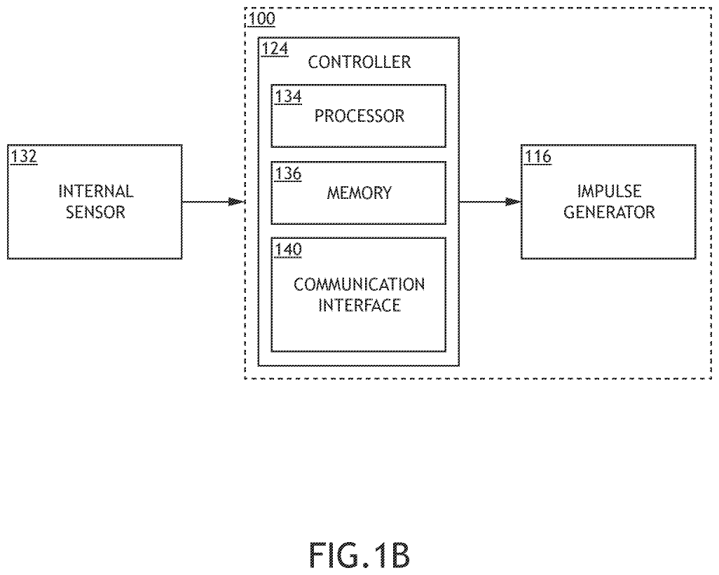

FIG. 1A is a diagram of a safety seat system 100, in accordance with one or more embodiments of the disclosure. The safety seat system 100 may be utilized by any type of vehicle or transportation technology including but not limited to aircraft, automobiles, locomotives, and spacecraft. The safety seat system 100 may include a seat 102 and safety components described herein, or may include only the safety components. For safety seat systems 100 that include a portion of the seat 102, the safety seat system 100 may also include a seat frame 104, a seat pan 108 coupled to the seat frame 104, and/or a seat back 112 coupled to the seat frame 104. The seat frame 104, seat pan 108 and seat back 112 may be configured for any type of seat, such as an aircraft passenger seat.

In embodiments, the safety seat system 100 includes an impulse generator 116 configured to deliver a compression load 150 to the spine of a sitting passenger to reduce a risk of injury. In embodiments, the impulse generator 116 is couplable to a portion of a component (e.g., a portion of the seat 102). For example, the portion may include (or be) a portion of a relatively rigid structure to support the forces the impulse generator 116 is configured to deliver. For instance, the impulse generator 116 may be couplable to the seat back 112, a seat shell, seat legs (not labeled), frame 104 (i.e., seat frame), other primary seat structure, other intermediate structure, and/or any other relatively rigid structure of, or proximate to, the seat 102. In this regard, the impulse generator 116 may be properly supported to serve a function of delivering a compression load 150.

In embodiments, the compression load 150 is applied during a sudden inertial event, such as a forward deceleration event. For example, the compression load 150 may be delivered as an aircraft decelerates after a rough landing or crash. In another example, the compression load 150 may be delivered as an automobile is stopped suddenly in an accident. The compression load 150 reduces the spinal tension in a passenger during sudden deceleration, reducing injury. The safety seat system 100 further includes a controller 124 configured to provide processing functionality for the system 100. For example, the controller may be configured to receive a forward deceleration signal 128 from an inertial sensor 132. In another example, the controller may be configured to activate the impulse generator 116 based on the received forward deceleration signal 128. In some embodiments, the safety seat system 100 includes the inertial sensor 132 (e.g., disposed either adjacent to, or remotely from, the impulse generator 116) and/or the seat belt 206. In some embodiments, the safety seat system 100 includes the impulse generator 116, the impulse generator 116 and the controller 124, or the impulse generator 116, the controller 124, and the inertial sensor 132. For example, the safety seat system 100 may be a modular device that is fitted onto a passenger seat.

The inertial sensor 132 may be configured as any sensor capable of measuring the acceleration/deceleration of an object along at least one axis. For example, the inertial sensor 132 may be configured as sensor that measures the acceleration/deceleration and angular velocity of on object along three mutually perpendicular axes. The inertial sensor 132 may include micro electro mechanical system (MEMS)-based sensors, accelerometers, gyroscope-assisted accelerometers, magnetometers, and the like.

FIG. 1B is a block diagram illustrating the electronic componentry of the safety seat system 100, in accordance with one or more embodiments of the disclosure. The controller 124 includes one or more processors 134, memory 136, and a communication interface 140. The one or more processors 134 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 134 may include any device configured to execute algorithms and/or instructions (e.g., program instructions stored in memory). In one embodiment, the one or more processors 134 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of the system 100 (e.g., the inertial sensor 132 and/or impulse generator 116) may include a processor 134 or logic elements suitable for carrying out at least a portion of the steps described in the present disclosure. Therefore, the above description should not be interpreted as a limitation on the embodiments of the present disclosure but merely as an illustration.

The memory 136 can be an example of tangible, computer-readable storage medium that provides storage functionality to store various data and/or program code associated with operation of the controller 124 and/or other components of the system 100, such as software programs and/or code segments, or other data to instruct the controller and/or other components to perform the functionality described herein. Thus, the memory 136 can store data, such as a program of instructions for operating the system 100 or other components. It should be noted that while a single memory 136 is described, a wide variety of types and combinations of memory 136 (e.g., tangible, non-transitory memory) can be employed. The memory 136 can be integral with the controller, can comprise stand-alone memory, or can be a combination of both. Some examples of the memory 136 can include removable and non-removable memory components, such as a programmable logic device, random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

The communication interface 140 can be operatively configured to communicate with components of the controller 124 and other components of the system 100. For example, the communication interface 140 can be configured to retrieve data from the controller 124 or other components, transmit data for storage in the memory 136, retrieve data from storage in the memory 136, and so forth. The communication interface 140 can also be communicatively coupled with controller 124 and/or system elements to facilitate data transfer between system components.

In some embodiments, the controller 124 is configured as circuitry disposed within and/or between the inertial sensor 132 and the impulse generator 116. For example, the inertial sensor 132 may send a signal directly to the impulse generator 116, which delivers the compression load 150. In this case, one or more functions of the controller 124 may be distributed within the inertial sensor 132, the impulse generator 116, and/or the circuitry between the inertial sensor 132 and the impulse generator 116.

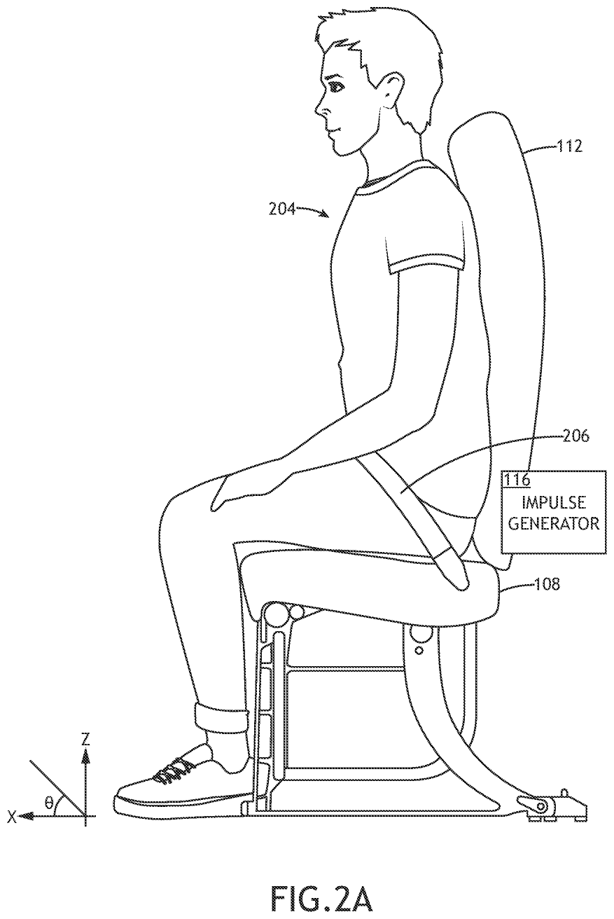

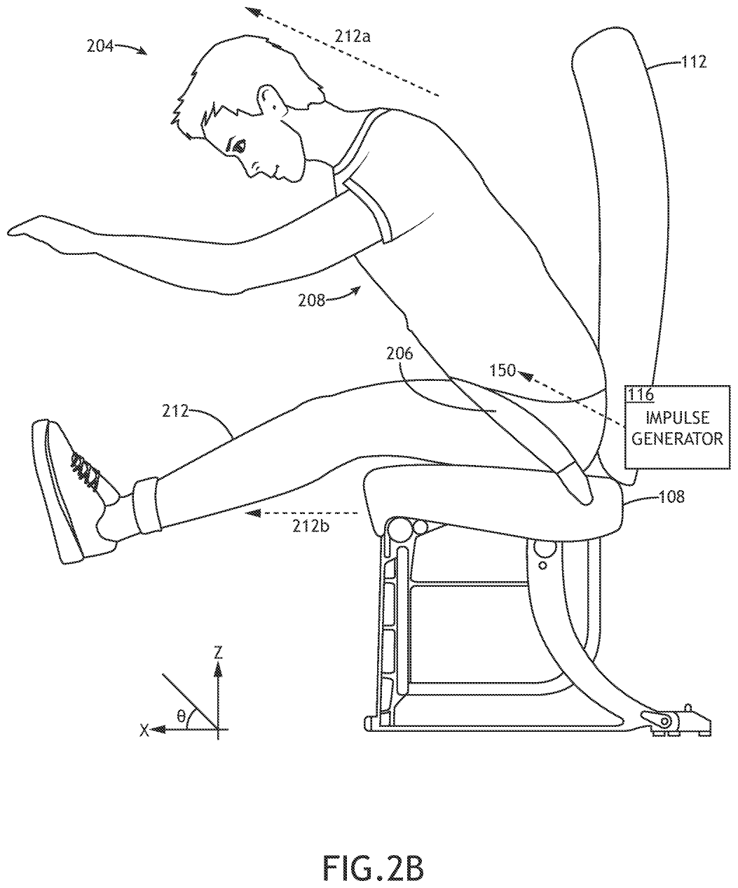

FIG. 2A-2B are diagrams illustrating the safety seat system 100 under normal travel conditions (e.g., as shown in FIG. 2A), and immediately after impulse generator 116 activation during a forward deceleration, free flailing, event (e.g., as shown in FIG. 2B). Under normal travel conditions, the passenger 204 is configured to be in a sitting position upon the seat pan 108. Upon a sudden forward deceleration event, such as a crash, the passenger is held into place via a seat belt 206. Although the seat belt 206 prevents the passenger from ejection from the passenger seat, the restraint of the seat belt 206 places particular stresses upon the spine of the passenger. For example, for a waist-only seat belt 206, the passenger will endure spinal tension loads 212 at both the middle and upper spine (e.g., tension load 212a) and lower spine e.g., (tension load 212b). If not mitigated, high tension loads on the spine can lead to severe spinal, pelvic, and head/neck injuries. For seat belts 206, with shoulder restraint, a sudden forward event may still lead to high tension loads 212a-b at the lower spine and upon the cervical vertebrae at the upper spine.

As demonstrated in FIG. 2B, the addition of a strong, low amplitude load 150 (e.g., a longitudinal compression force) by the impulse generator 116 during the point highest tension loads 212a, 212b counteracts the tension loads 212a, 212b, reducing the stress on the spine of the passenger 204, and reducing the risk of spinal injury. The compression load may be a single power ‘stroke’ that engages the spine or a series of power strokes configured to engage the spine during the forward deceleration event. The amplitude of the power stroke (e.g., the amount of distance an outer seat surface (e.g., surface configured to be near a passenger's lower back area) of the seat back is moved upward upon activation of the impulse generator) is considerably small. For example, the power stroke may be configured to be less than 2 inches/5.08 cm. In another example, the power stroke may be configured to be less than one inch/2.54 cm. In another example, the power stroke may be configured to be less than one-half inch/1.27 cm. In another example, the power stroke may be configured to a quarter inch/0.635 cm. In another example, the power stroke may be configured to be less than a quarter inch/0.635 cm. Because the power stroke is considerably small, the seat back 112 can be fixed to the seat frame 104 with no need for a pivot or hinge, as the seat back 112 may accommodate the power stroke via a small deformation of the seat back 112 that raises an outer seat surface.

It should be noted that the controller 124 may configured to time the action of the impulse generator 116 so that the compression load 150 can mitigate the tension loads 212 when they are at their greatest. For example, when the controller 124 receives a forward deceleration signal 128 from the inertial sensor 132, the controller 124 may be programmed to calculate an estimate of the most appropriate time to activate the impulse generator and/or the characteristic of the impulse(s). For instance, for an aircraft taxiing at 50 km/hr (31 mph) and decelerating to a full stop in 0.5 s (a 2.8 g event), the inertial sensor 132 may transmit to the controller 124 that a relatively slow speed, low g deceleration event is occurring. The impulse generator 116 may then deliver a compression load 150 one or more pulses (e.g., of low intensity and/or low frequency) over the estimated deceleration time. In another example, for an aircraft hitting the side of a mountain at 150 km/hr (93 mph) and stopping in 0.42 seconds (a 10 g event), the inertial sensor 132 may transmit to the controller 124 that is relative fast speed, high g deceleration event is occurring. The impulse generator 116 may then deliver a compression load 150 one or more pulses (e.g., of high intensity and/or high frequency) over the estimated deceleration time. In embodiments, the controller 124 signals the impulse generator 116 to deliver the compression load 150 at the appropriate time (e.g., taking into consideration the time that it takes for the impulse generator 116 to deliver the compression load 150.

It should be understood that the compression load 150 may be directed at any angle, but generally may include angles at least partially in the forward/longitudinal direction (e.g., see X-direction in FIG. 2B). For example, the compression load may be directed at an angle that includes, but is not necessarily limited to, −5 degrees (in the X-Z plane measured relative to the X-direction), 0 degrees, 5 degrees, 10 degrees, 15 degrees, 20 degrees, 30 degrees, 40 degrees, and/or the like. For example, the angle may be represented by angle θ in the X-Z plane as shown in FIG. 1A. For instance, the longitudinal angle may be a particular angle (e.g., a value listed above) or less, within plus or minus 5 degrees of the particular angle, and/or the like. Note that the X-direction as shown may be a forward direction generally. In some embodiments, the X-direction is defined as a forward direction of a vehicle, a likely direction of momentum in the event of a free flail incident, a direction a passenger of a seat is facing, and/or the like. As shown in FIGS. 1A and 2B, the compression load 150 is meant to represent an angle of about 10 degrees.

In some cases, the force applied to the posterior of the spine may differ spatially or by angle based on the type or intensity of the deceleration.

The impulse generator 116 may include any technology that can provide a compression load 150, or a series of compression loads 150 or pulses upon to the spine of the passenger 204. In general, the impulse generator 116 includes an energy source (e.g., a stored energy source such as energy source 350) that can provide a load 150. The impulse generator 116 may include at least one of a piston (not shown) or load plate 352 configured to translate based on the load 150. The energy source 350, piston and/or load plate 352 may be disposed partially or fully within the seat back 112.

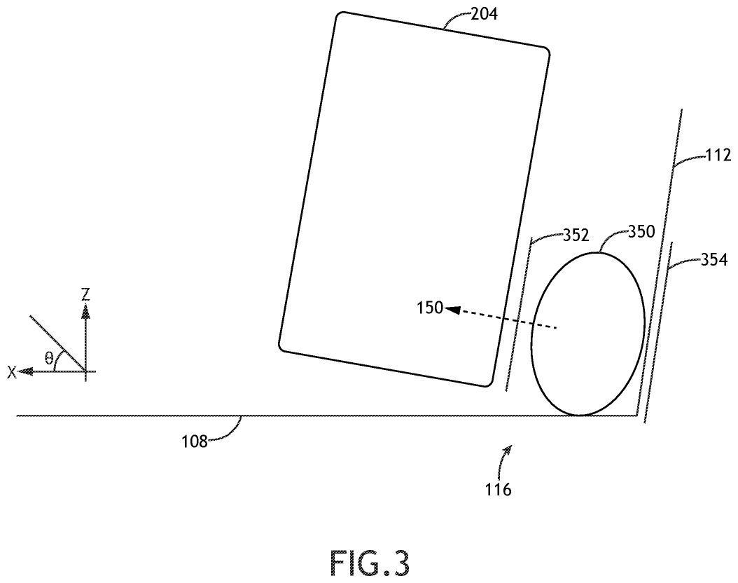

Many arrangements/configurations of the energy source 350 are possible. For example, the impulse generator 116 may be configured such that an energy source (e.g., energy source 350, energy source 304) drives a piston that is coupled to a plate (e.g., the load plate 352), as shown in FIG. 3A of U.S. patent application Ser. No. 17/705,614, filed Mar. 28, 2022, which is hereby incorporated by reference in its entirety. In another example, the impulse generator 116 may be configured such that energy source drives only the plate, as shown in FIG. 3B of U.S. patent application Ser. No. 17/705,614. In another example, the impulse generator 116 may be configured such that energy source only drives the piston, as shown in FIG. 3C of U.S. patent application Ser. No. 17/705,614. In another example, the impulse generator 116 may be configured such that energy source initially drives a first load plate that is coupled to the piston 208, which ultimately drives a second load plate, as shown in FIG. 3D of U.S. patent application Ser. No. 17/705,614.

FIG. 3 is a diagram illustrating the safety seat system, including the energy source 350, in accordance with one or more embodiments of the disclosure.

The energy source 350 may include any type mechanical, electrical, or chemical power device. For example, the energy source 350 may comprise a chemical energy system that includes at least one explosive or expansion charge based on a chemical reaction.

By way of another example, the energy source may be an airbag. For example, FIG. 3 may illustrate an airbag configured to be expanded. For instance, the chemical energy system may use a sodium azide-based reaction used in airbags to provide/impart the load 150 that translates the load plate 352. The seat back may include a back stop support 354 (e.g., support plate). The back stop support 354 may be configured (e.g., via location behind the energy source 350), to provide a surface, support, and/or the like to push off of when applying the load 150. The back stop support 354 may be (structurally) coupled to (and/or be a portion of) the seat back 112, frame 104, and/or the like.

In another instance, the chemical energy system may be configured as a ballistic charge containing a gun powder or other type of propellant. The chemical energy system may include several ballistic charges of one or more different intensities. For example, the chemical energy system may include an initial heavy charge to initiate spinal compression load, followed by a quick succession of smaller charges to keep the spine in a loaded state.

In some embodiments, the energy source 350 may comprise one or more loaded springs. For instance, the impulse generator 116 may store a compression spring in a loaded state, kept in the compression state via a latch. Upon receiving an activation signal from the controller 124, the impulse generator 116 may release the latch, with the compressed spring providing the load 150 to the piston and/or load plate 352.

In some embodiments, the energy source 350 may comprise a compressed gas. For example, the impulse generator 116 may store a compressed gas container containing a compressed gas, such as nitrogen or other inert gas, that is coupled to a chamber within the piston, with a valve that is disposed between the compressed gas container and the chamber that keeps gas from flowing into the chamber under normal conditions. Upon receiving the activation signal from the controller 124, the impulse generator 116 may release the valve, and the compressed gas rushing into the chamber, providing the load 150 to the piston. In another example, the energy source 350 may comprise a gas spring coupled to, or integrated into, the piston. For instance, the gas spring may be stored in a loaded position that this subsequently released upon activation by the controller 124.

In some embodiments, the energy source 350 compress and electrical source (e.g., sourced from a local battery or vehicle power). For example, the impulse generator 116 may comprise a solenoid that the piston can fit into. Upon receiving the activation signal from the controller 124, the impulse generator 116 (or the controller 124) may send an electrical pulse to the solenoid, causing a translation of the piston, providing the load 150.

In some embodiments, the energy source 350 powers a mechanical device that provides the compression load 150. For example, the energy source 350 may power a rotating cam assembly. For instance, the energy source may be configured as battery or vehicle electrical power source that powers an electric motor that rotates the cam via a shaft. The nose of the cam may strike a piston or load plate, which delivers/imparts the compression load 150. In another instance, the cam may be rotated by hydraulic means, via a hydraulic pump powered by the energy source 350. The controller 124 and/or impulse generator 116 may control the speed of the rotating cam, providing multiple impulses during a forward deceleration event. In some embodiments, a rotation profile may be generated by the controller 124 based on the type and severity of the forward deceleration event. For instance, controller may increase the speed of the shaft based upon the anticipated g-force sustained during the forward deceleration event. The rotation of the cam may also be powered via a coiled spring or other stored energy device.

The safety seat system 100 may include a segmented seat back layer, that changes confirmation upon activation of the impulse generator 116. For example, the segmented seat back layer may buckle during an impulse generator activation, causing a peak to form in the segmented seat back layer. The formation of the peak coincides with the application of a compression load 150 to the passenger 204.

It is noted that although the examples of inertial events in this disclosure describe forward deceleration events, that the safety seat system 100 may be configured to mitigate spinal tension upon any acceleration or deceleration of a passenger 204. For example, the safety seat system 100 may be implemented in an automobile and deliver a compression load 150 upon a side impact by another automobile. Therefore, the above description should not be interpreted as a limitation on the embodiments of the present disclosure but merely as an illustration.

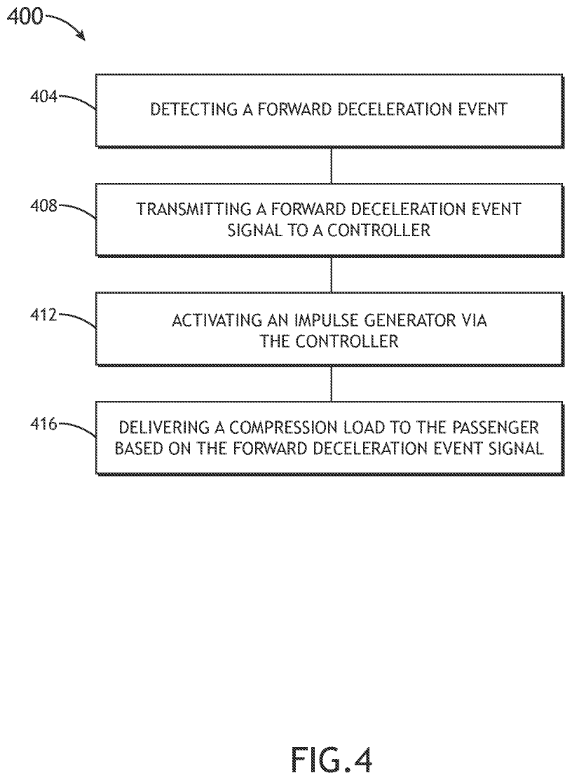

FIG. 4 is a block diagram illustrating a method 400 for delivering a compression load 150 to a passenger 204, in accordance with one or more embodiments of the disclosure. In some embodiments, the method 400 includes a step 404 of detecting a forward deceleration event. For example, the forward deceleration event (e.g., the initial microseconds/milliseconds of a vehicle crash) may be detected via an inertial sensor 132.

In some embodiments, the method 400 may further include a step 408 transmitting the forward deceleration signal 128 to the controller 124. For example, the inertial sensor 132 may send the forward deceleration signal 128 to the controller 124 in the form of a wireless message.

In some embodiments, the method 400 may further include a step 412 of activating an impulse generator 116 via the controller 124. For example, the controller 124 may send an electrical impulse to an impulse generator 116 that ignites, or leads to the ignition, of a sodium azide-based chemical reaction within the impulse generator 116. In another example, the controller 124 may send an electrical signal controlling, or instructing the impulse generator 116 to control, the cam assembly.

In some embodiments, the method 400 may further include a step 416 of delivering a compression load 150 to the passenger based on the forward deceleration signal 128. Once activated via the controller 124, the impulse generator 116 translates piston and/or load plate 352 vertically. A passenger 204 sitting on the seat pan 108 during this translation event will feel a small pulse, or a series of pulses, coming from the seat 102 (e.g., seat back 112, and/or seat pan 108). The intent of the translation is not necessarily to physically move the passenger 204, but rather to engage the spine of the passenger 204, such as may reduce a peak stress (e.g., peak lumbar tension) that may arise during a crash. Injuries such as fractures, sprains, and the like may result from a peak load, rather than the accumulation of smaller, less harmful loads.

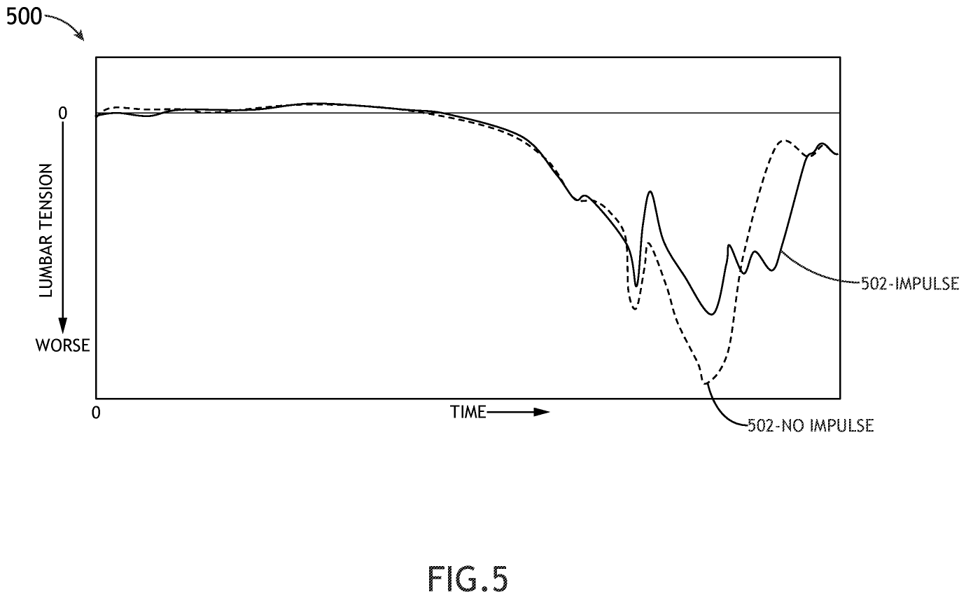

FIG. 5 is a chart 500 illustrating lumbar tension versus time with and without an impulse (e.g., load 150), in accordance with one or more embodiments of the disclosure.

The chart 500 may illustrate a rough conceptual approximation of a difference between simulated lumbar tension of a passenger who receives a compression load 150 (i.e., lumbar tension with pulse 504) and simulated lumbar tension of a passenger who does not receive a compression load 150 (i.e., lumbar tension without pulse 502) as plotted over time (e.g., roughly 250 milliseconds). As shown, the baseline (e.g., lumbar tension without pulse 502) includes a peak absolute value that is greater (worse) than the peak absolute value of the lumbar tension with pulse 504. It is noted that the overall amount of tension received over time (e.g., area between a tension curve profile and zero) does not necessarily need to be reduced in order to reduce the peak absolute value of tension.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A safety seat system for a vehicle comprising:
an impulse generator couplable to a seat configured to provide a compression load onto a spine of a sitting passenger during a forward deceleration event; and
a controller communicatively coupled to the impulse generator and an inertial sensor comprising:
one or more processors; and
a memory with instructions stored upon, wherein the instructions, upon execution by the one or more processors, cause the one or more processors to:
receive a forward deceleration signal from the inertial sensor; and
activate the impulse generator based on the forward deceleration signal.

2. The safety seat system of claim 1, wherein the impulse generator is couplable to at least one of a frame or a seat back of the seat.

3. The safety seat system of claim 2, wherein the safety seat system further comprises the at least one of the frame or the seat back.

4. The safety seat system of claim 1, wherein the compression load is configured as a series of impulses.

5. The safety seat system of claim 1, wherein the impulse generator comprises a rotating cam assembly that includes a cam, wherein a nose of the cam imparts the compression load.

6. The safety seat system of claim 1, wherein the impulse generator comprises a chemical energy system that includes at least one explosive or expansion charge that imparts the compression load.

7. The safety seat system of claim 1, wherein the impulse generator comprises:
a stored energy source; and
at least one of a piston or load plate mechanically coupled to the stored energy source and to the seat back, wherein upon a release of a stored energy from the stored energy source translates the piston or the load plate, wherein a translation of the piston or load plate provides the compression load.

8. The safety seat system of claim 7, wherein the stored energy source is configured as an airbag.

9. The safety seat system of claim 7, wherein the stored energy source is configured as an explosive.

10. The safety seat system of claim 7, wherein the stored energy source is configured as a compressed gas or a gas spring.

11. The safety seat system of claim 1, wherein the impulse generator comprises:
a solenoid; and
a piston mechanically disposed within the solenoid and mechanically coupled to a seat pan, wherein an activation of the solenoid translates the piston, wherein a translation of the piston provides the compression load.

12. The safety seat system of claim 1, further comprising the inertial sensor.

13. The safety seat system of claim 1, further comprising a seat belt.

14. A method for delivering a compression load to a passenger comprising:
detecting a forward deceleration event;
transmitting a forward deceleration event signal to a controller;
activating an impulse generator via the controller; and
delivering a compression load to the passenger based on the forward deceleration event signal.

15. The method of claim 14, wherein delivering the compression load comprises expanding an airbag.
